(19) United States
(12) Patent Application Publication
(10) Pub. No.: US 2018/0239334 A1
(43) Pub. Date: Aug. 23, 2018

(54) SYSTEMS AND METHODS FOR IMPROVED PART DESIGN AND INSPECTION

(71) Applicant: General Electric Company, Schenectady, NY (US)

(72) Inventors: John Madison Tramel, JR., Roebuck, SC (US); Tao Jia, Glenville, NY (US)

(21) Appl. No.: 15/440,723

(22) Filed: Feb. 23, 2017

(51) Int. Cl. G05B 19/4097; G06F 17/50; G01B 21/04

(52) U.S. Cl. CPC G05B 19/4097; G06F 17/5009; G05B 2219/35134; G06F 2217/12; G01B 21/04

(57) ABSTRACT

In one embodiment, a computer-aided technology (CAx) system includes memory storing a producibility advisor system and a processor communicatively coupled to the memory. The processor is configured to execute the producibility advisory system to receive a part design as input, and to derive a producibility report based on the part design, wherein the producibility report comprises a measure of an ability of a machine to manufacture a part based on the part design.

### BACKGROUND OF THE INVENTION

The subject matter disclosed herein relates to systems and methods for design and inspection of parts, such as industrial machine parts.

Certain design and inspection techniques may be used to create a variety of machinery, including industrial machines. Industrial machines, such as gas turbine systems, may provide for the generation of power. For example, the gas turbine systems typically include a compressor for compressing a working fluid, such as air, a combustor for combusting the compressed working fluid with fuel, and a turbine for turning the combusted fluid into a rotative power. For example, the compressed air is injected into a combustor, which heats the fluid causing it to expand, and the expanded fluid is forced through the gas turbine. The gas turbine may then convert the expanded fluid into rotative power, for example, by a series of blade stages. The rotative power may then be used to drive a load, which may include an electrical generator producing electrical power and electrically coupled to a power distribution grid. Industrial machines and machine parts may be designed for a particular purpose, such as a compressor blade designed to compress air. The machine or part may then be inspected for its ability to fulfill its design purpose. It may be beneficial to improve the design and inspection of machine and machine parts.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a computer-aided technology (CAx) system includes memory storing a producibility advisor system and a processor communicatively coupled to the memory. The processor is configured to execute the producibility advisory system to receive a part design as input, and to derive a producibility report based on the part design, wherein the producibility report comprises a measure of an ability of a machine to manufacture a part based on the part design.

In a second embodiment, a method includes receiving, via a processor, a part design, wherein the part design is created via a computer aided design (CAD) system. The method additionally includes providing as input, via the processor, the part design to a producibility advisor system. The method further includes executing the producibility advisor system, via the processor, to derive a producibility report based on the part design, wherein the producibility report comprises a measure of an ability of a machine to manufacture a part based on the part design.

In a third embodiment, one or more tangible, non-transitory, machine-readable media including instructions that cause a processor to receive a part design, wherein the part design is created via a computer aided design (CAD) system. The instructions additionally cause the processor to provide as input the part design to a producibility advisor system. The instructions further cause the processor to execute the producibility advisor system to derive a producibility report based on the part design, wherein the producibility report comprises a measure of an ability of a machine to manufacture a part based on the part design.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a computer-aided technology (CAx) system;

FIG. 2 is a block diagram of embodiments of certain components of the CAx system of FIG. 1;

FIG. 3 is block diagram of an embodiment, of an industrial system that may be conceived, designed, engineered, manufactured, and/or service and tracked by the CAx system of FIG. 1; and

FIG. 4 is a flowchart of an embodiment of a process suitable for incorporating one or more feedback loops to automatically calibrate manufacturing machines and/or a producibility advisor system.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Designing a machine or part may include certain systems and methods described in more detail below that produce a design for a part or product. For example, the design may be created as a model-based definition included in a 3-dimensional (3D) computer aided design (CAD) model and associated product and manufacturing information (PMI). The techniques described herein may not create typical engineering part drawing or drawings, as the CAD model and PMI may contain all part dimensional and tolerance information, as further described below.

After creating the design, a producibility advisor system may be executed using the design as input. The producibility advisor may automatically check for compliance with known manufacturing capabilities, thus enabling a more efficient manufacturing with reduced cost and cycle times. Deviations from certain rules may be flagged by the producibility advisor system and subsequently corrected, for example, prior to design release to manufacturing. The part may then get manufactured and subsequently inspected. An inspection program or code for a Coordinate-Measuring Machine (CMM) may then be automatically derived based on the part design. The CMM may then automatically inspect the part based on the derived inspection program.

After the part is inspected, results from the CMM are automatically generated via an electronic Characteristic Accountability & Verification (eCAV) system. The eCAV system may then communicate with a Data Analysis (DA) system that may derive certain conclusions based around machine capability for the part and may then employ, for example, a logic tree to trigger a calibration to machine settings, to the producibility advisor system, or a combination thereof. By automatically calibrating machine settings and/or the producibility advisor system to improve the design via feedback, the part or product may be manufactured more efficiently and accurately.

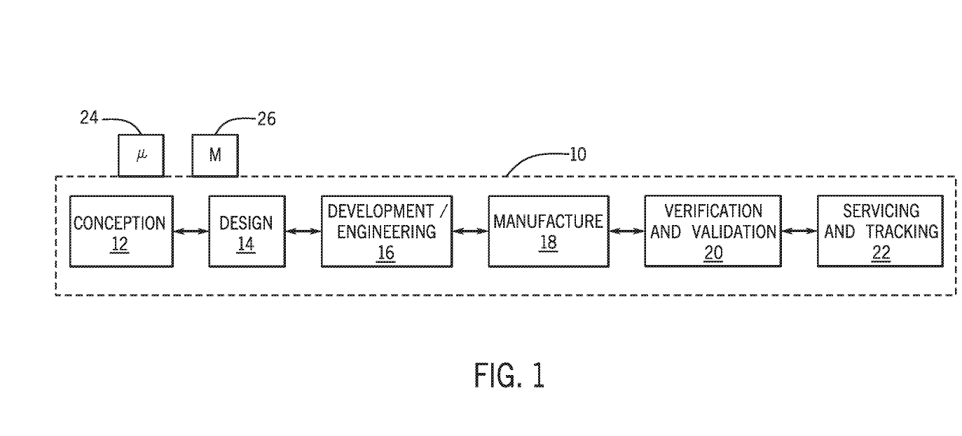

With the foregoing in mind, it may be useful to describe a computer-aided technologies (CAx) system that may incorporate the techniques described herein, for example suitable for executing one or more product lifecycle management (PLM) processes. Accordingly, FIG. 1 illustrates an embodiment of a CAx system 10 suitable for providing for a variety of processes, including PLM processes 12, 14, 16, 18, 20, 22. In the depicted embodiment, the CAx system 10 may include support for execution of conception processes 12. For example, the conception processes 12 may produce a set of specifications such as requirements specifications documenting a set of requirements to be satisfied by a design, a part, a product, or a combination thereof. The conception processes 12 may also produce a concept or prototype for the part or product (e.g., machinery, electronics, structures, or a combination thereof). A series of design processes 14 may then use the specifications and/or prototype to produce, for example, one or more 3D design models of the part or product. The 3D design models may include solid/surface modeling, parametric models, wireframe models, vector models, non-uniform rational basis spline (NURBS) models, geometric models, and the like, describing part geometries and structures. The PMI may include geometric dimensions, tolerances, text (e.g., annotations, notes), other dimensions, material type, material specifications, finishes (e.g., surface finishes), clearances, and so on, associated with the 3D models.

Design models may then be further refined and added to via the execution of development/engineering processes 16. The development/engineering processes may, for example, create and apply models such as thermodynamic models, low cycle fatigue (LCF) life prediction models, multibody dynamics (MBD) and kinematics models, computational fluid dynamics (CFD) models, finite element analysis (FEA) models, and/or 3-dimension to 2-dimension FEA mapping models that may be used to predict the behavior of the part or product during its operation. For example, turbine blades may be modeled to predict fluid flows, pressures, clearances, and the like, during operations of a gas turbine engine. The development/engineering processes 16 may additionally result in the tolerances, materials specifications (e.g., material type, material hardness), clearance specifications, and the like, useful in manufacturing the part or product and stored in the PMI.

The CAx system 10 may additionally provide for manufacturing processes 18 that may include manufacturing automation support. For example, additive manufacturing models may be derived, such as 3D printing models for material jetting, binder jetting, vat photopolymerization, powder bed fusion, sheet lamination, directed energy deposition, material extrusion, and the like, to create the part or product. Other manufacturing models may be derived, such as computer numeric control (CNC) models with G-code to machine or otherwise remove material to produce the part or product (e.g., via milling, lathing, plasma cutting, wire cutting, and so on). Bill of materials (BOM) creation, requisition orders, purchasing orders, and the like, may also be provided as part of the manufacture processes 18 (or other PLM processes).

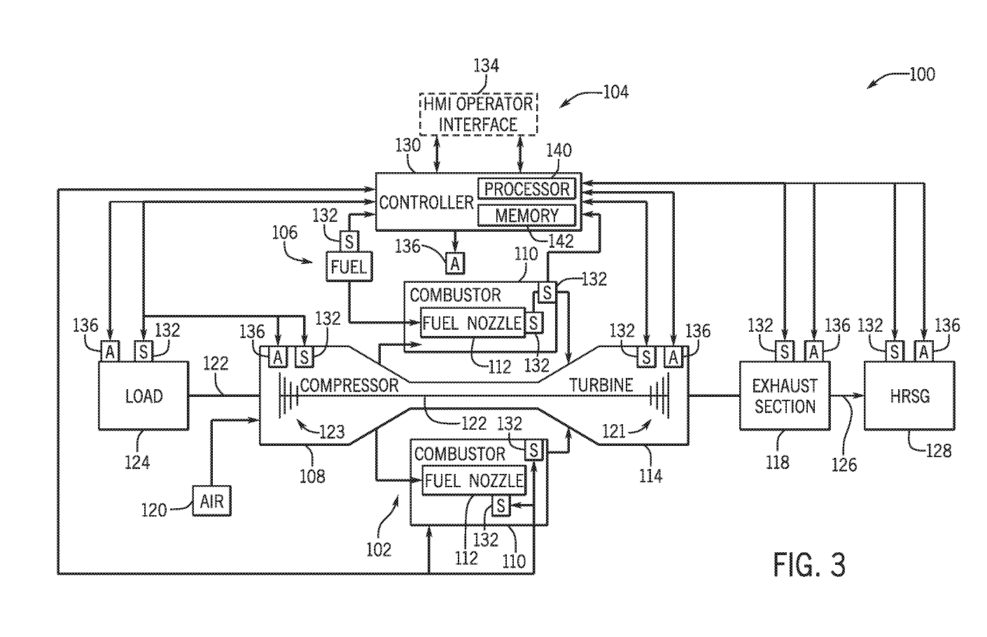

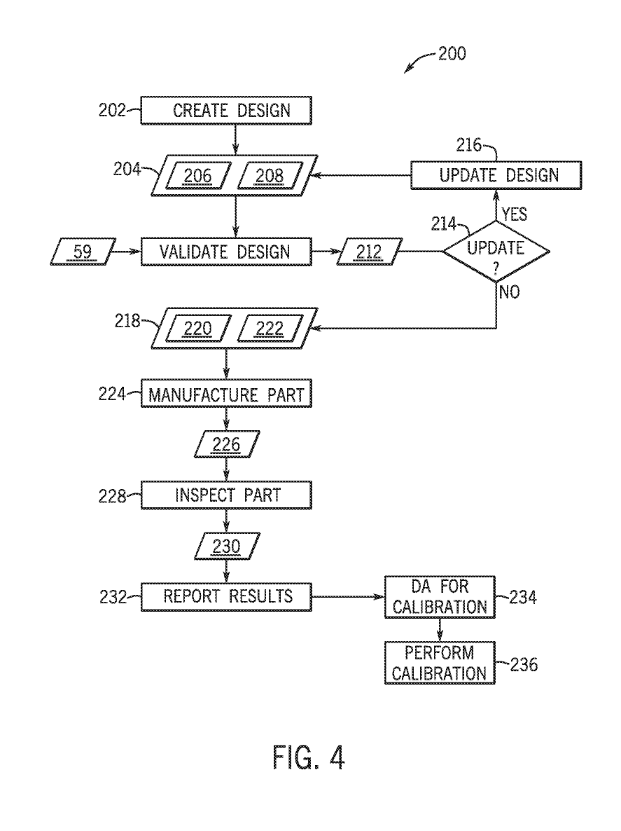

The CAx system 10 may additionally provide for verification and/or validation processes 20 that may include automated inspection of the part or product as well as automated comparison of specifications, requirements, and the like. In one example, a coordinate-measuring machine (CMM) process may be used to automate inspection of the part or product. After the part is inspected, results from the CMM process may be automatically generated via an electronic Characteristic Accountability & Verification (eCAV) system. The eCAV system may then communicate with a Data Analysis (DA) system that may derive certain conclusions based around machine capability for the part and may then employ, for example, a logic tree to trigger a calibration to machine settings, to the a producibility advisor system, or a combination thereof, as described in more detail below with respect to FIGS. 3 and 4. By automatically calibrating machine settings and/or the producibility advisor system, the part may be manufactured more efficiently and accurately.

A servicing and tracking set of processes 22 may also be provided via the CAx system 10. The servicing and tracking processes 22 may log maintenance activities for the part, part replacements, part life (e.g., in fired hours), and so on. As illustrated, the CAx system 10 may include feedback between the processes 12, 14, 16, 18, 20, 22. For example, data from services and tracking processes 22, for example, may be used to redesign the part or product via the design processes 14. Indeed, data from any one of the processes 12, 14, 16, 18, 20, 22 may be automatically provided and used by any other of the processes 12, 14, 16, 18, 20, 22 to improve the part or product or to create a new part or a new product. In this manner, the CAx system 10 may incorporate data from downstream (or upstream) processes and use the data to improve the part or to create a new part.

The CAx system 10 may additionally include one or more processors 24 and a memory system 26 that may execute software programs to perform the disclosed techniques. Moreover, the processors 24 may include multiple microprocessors, one or more “general-purpose” microprocessors, one or more special-purpose microprocessors, and/or one or more application specific integrated circuits (ASICS), or some combination thereof. For example, the processors 24 may include one or more reduced instruction set (RISC) processors. The processors may additionally be included in a cloud-based system that provides for the processes 12, 14, 16, 18, 20, 22 as cloud-based services. The memory system 26 may store information such as control software, look up tables, configuration data, etc. The memory system 26 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof).

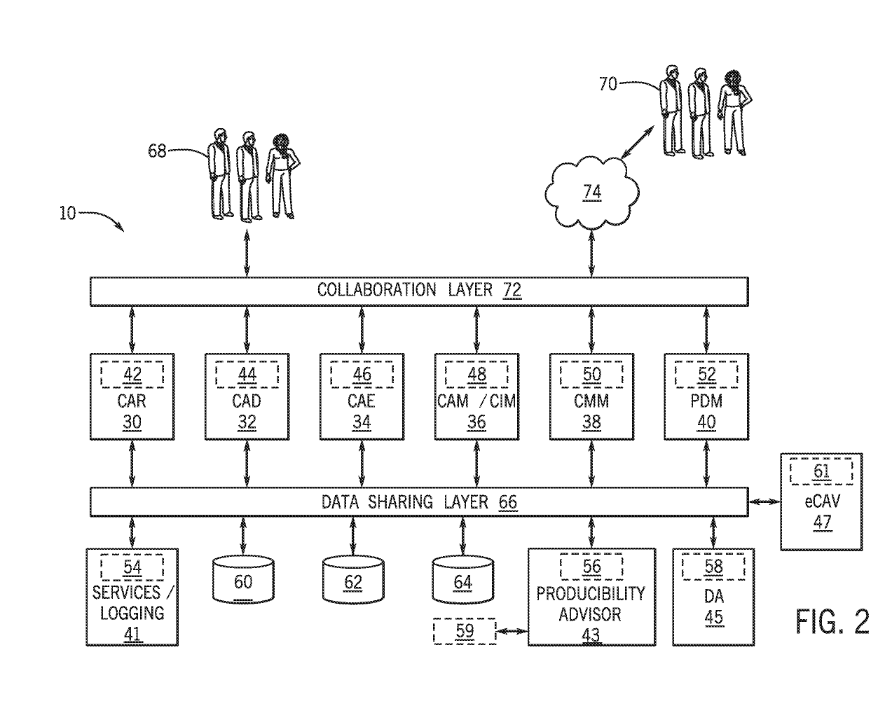

The memory system 26 may store a variety of information, which may be suitable for various purposes. For example, the memory system 26 may store machine-readable and/or processor-executable instructions (e.g., firmware or software) for the processors' 24 execution. In one embodiment, the executable instructions include instructions for a number of PLM systems, for example software systems, as shown in the embodiment of FIG. 2. More specifically, the CAx system 10 embodiment illustrates a computer-aided requirements capture (CAR) system 30, a computer-aided design (CAD) system 32, a computer-aided engineering (CAE) system 34, computer-aided manufacturing/computer-integrated manufacturing (CAM/CIM) system 36, a coordinate-measuring machine (CMM) system 38, and a product data management (PDM) system 40, a services/logging system 41, a producibility advisor system 43, a data analysis (DA) system 45, and an electronic characteristic accountability & verification (eCAV) system 47. Each of the systems 30, 32, 34, 36, 38, 40, 41, 43, 45, and 47 may be extensible and/or customizable; accordingly, each system 30 may include an extensibility and customization system 42, 44, 46, 48, 50, 52, 54, 56, 58 and 61, respectively. Additionally, each of the systems 30, 32, 34, 36, 38, 40, 41, 43, 45, and 47 may be stored in a memory system, such as memory system 26, and may be executable via a processor, such as via processors 24.

In the depicted embodiment, the CAR system 30 may provide for entry of requirements and/or specifications, such as dimensions for the part or product, operational conditions that the part or product is expected to encounter (e.g., temperatures, pressures), certifications to be adhered to, quality control requirements, performance requirements, and so on. The CAD system 32 may provide for a graphical user interface suitable to create and manipulate graphical representations of 2D and/or 3D models as described above with respect to the design processes 14. For example, the 3D design models may include solid/surface modeling, parametric models, wireframe models, vector models, non-uniform rational basis spline (NURBS) models, geometric models, and the like. The CAD system 32 may provide for the creation and update of the 2D and/or 3D models and related information (e.g., views, drawings, annotations, notes, and so on). Indeed, the CAD system 32 may combine a graphical representation of the part or product with other, related information.

The CAE system 34 may enable creation of various engineering models, such as the models described above with respect to the development/engineering processes 16. For example, the CAE system 34 may apply engineering principles to create models such as thermodynamic models, low cycle fatigue (LCF) life prediction models, multibody dynamics (MBD) and kinematics models, computational fluid dynamics (CFD) models, finite element analysis (FEA) models, and/or 3-dimension to 2-dimension FEA mapping models. The CAE system 34 may then apply the aforementioned models to analyze certain part or product properties (e.g., physical properties, thermodynamic properties, fluid flow properties, and so on), for example, to better match the requirements and specifications for the part or product.

The CAM/CIM system 36 may provide for certain automation and manufacturing efficiencies, for example, by deriving certain programs or code (e.g., G-code) and then executing the programs or code to manufacture the part or product. The CAM/CIM system 36 may support certain automated manufacturing techniques, such as additive (or subtractive) manufacturing techniques, including material jetting, binder jetting, vat photopolymerization, powder bed fusion, sheet lamination, directed energy deposition, material extrusion, milling, lathing, plasma cutting, wire cutting, or a combination thereof The CMM system 38 may include machinery to automate inspections. For example, probe-based, camera-based, and/or sensor-based machinery may automatically inspect the part or product to ensure compliance with certain design geometries, tolerances, shapes, and so on.

The PDM system 40 may be responsible for the management and publication of data from the systems 30, 32, 34, 36, 38, 40, 41, 43, 45, and/or 47. For example, the systems 30, 32, 34, 36, 38, 40, 41, 43, 45, and 47 may communicate with data repositories 60, 62, 64 via a data sharing layer 66. The PDM system 40 may then manage collaboration between the systems 30, 32, 34, 36, 38, 40, 41, 43, 45, and 47 by providing for data translation services, versioning support, data archive management, notices of updates, and so on. The PDM system 40 may additionally provide for business support such as interfacing with supplier/vendor systems and/or logistics systems for purchasing, invoicing, order tracking, and so on. The PDM system 40 may also interface with the service/logging system 41 (e.g., service center data management systems) to aid in tracking the maintenance and life cycle of the part or product as it undergoes operations. Teams 68, 70 may collaborate with team members via a collaboration layer 72. The collaboration layer 72 may include web interfaces, messaging systems, file drop/pickup systems, and the like, suitable for sharing information and a variety of data. The collaboration layer 72 may also include cloud-based systems 74 or communicate with the cloud-based systems 74 that may provide for decentralized computing services and file storage. For example, portions (or all) of the systems 30, 32, 34, 36, 38, 40, 41, 43, 45, and 47 may be stored in the cloud 74, be executable in the cloud 74, and/or accessible via the cloud 74.

The services/logging system 41 may include shop systems that are used to service a variety of machinery, and that may thus log replacement of parts, track a specific part use in a specific device, track number of hours of use, track maintenance performed, and so on. In one embodiment, the services/logging system 41 may be fleet-based. That is, the services/logging system 41 may store and analyze data for a fleet of machinery, such as a fleet of power-production machinery described in more detail with respect to FIG. 3.

The producibility advisor system 43 may include or have access to a user-configurable set of design producibility rules 59 to aid in evaluating the producibility of a part or product design. The producibility rules 59 may include knowledge system rules (e.g., forward-chained expert system rules, backward chained expert system rules, classification rules, formal logic rules, first order logic rules, and/or propositional logic rules) suitable for deriving if a given design is producible based on current manufacturing capabilities, on design features, on the PMI, and so on. That is, the producibility advisor system 43 may provide for automated guidance focused on the design's compliance with manufacturing techniques, on improving the creation of the part or product, on improving the part or product's ability to operate as specified in its design, on improving the part or product's quality, on improving the engineering of the part or product, improving manufacturing (e.g., manufacturing efficiency, use of materials, manufacturing time) and/or on lowering manufacturing cost for the part or product. In one embodiment, the producibility advisor system 43 may execute the producibility rules 59 to derive one or more producibility reports, metrics, and the like, detailing or otherwise assessing the part or product's design and product and manufacturing information (PMI) compliance with manufacturing techniques, such as additive and/or subtractive manufacturing. Likewise, the producibility reports and metrics may detail or aid in detailing changes in design, in geometries, in tolerances, in machine settings, in machine calibrations, and so on, useful to improve the part or product and/or the manufacturing processes. Accordingly, the design may be updated, including automatic updates, based on the producibility advisor system 43 metrics and reports.

Once the design is updated, the part may then be manufactured and then inspected, for example via the CMM system 38. In one embodiment, the CAD system 32 may automatically generate CMM code (e.g., dimension suitable for inspecting the manufactured design. For example, the code (e.g., dimensional measuring interface standard [DMIS] code, CALYPSO code) may include a set of locations on the part or product that the CMM system may inspect via a probe, a laser, a camera, and so on. The code may additionally include travel paths, a complete measurement plan, allowable variations, for example, in geometry, and so on. Results from the inspection are used as input to the eCAV system 47. The eCAV system 47 may then automatically generate a first article inspection report and/or metrics detailing the measured geometries, position of holes, type of holes (e.g., through-holes, partial holes), hole depth, hole diameter, hole shape, distance between edges, surface finish, color, and so on.

The eCAV 47 system's output may be used as input for the DA system 45. The DA system 45 may process the eCAV 47 system's output to automatically generate calibrations for the machine used to produce the part or product (e.g., CAM\CIM system 48 calibrations, CNC machine calibrations, 3D printer calibrations). For example, machine offsets, zeroes, touch offs, cutting compensations, printing bed adjustments, printing bed temperature, and so on, may be adjusted. Additionally or alternatively, the DA system 45 may process the eCAV 47 system's output to automatically generate calibrations for the producibility advisor system 43. For example, producibility rules 59 may be “tuned” so that the newer designs analyzed by the producibility advisor system 43 may be more efficiently manufactured, may result in improved parts operations/life, and may reduce overall costs, thus improving efficiency. The DA system 45 may also process data from service/logging system 41 (e.g., data produced by the servicing and tracking processes 22) to derive the machine calibrations as well as the producibility advisor system 43 calibrations. For example, parts wear data may be used to change material types and/or to change geometries. Likewise, parts replacement data, outage data, life expectancy data, and so on, may be used by the DA system 45 to automatically derive the machine and/or producibility advisor system 43 calibrations.

The extensibility and customization systems 42, 44, 46, 48, 50, 52, 54, 56, 58 and 61 may provide for functionality not found natively in the CAR system 30, the CAD system 32, the CAM/CIM system 36, the CMM system 38, the PDM system 40, the services/logging system 41, the producibility advisor system 43, the DA system 45, and/or the eCAV system 47. For example, computer code or instructions may be added to the systems 30, 32, 34, 36, 38, 40, 41, 43, 45, and 47 via shared libraries, modules, software subsystems and the like, included in the extensibility and customization systems 42, 44, 46, 48, 50, 52, 54, 56, 58 and/or 61. The extensibility and customization systems 42, 44, 46, 48, 50, 52, 54, 56, 58 and 61 may also use application programming interfaces (APIs) included in their respective systems 30, 32, 34, 36, 38, 40, 41, 43, 45, and 47 to execute certain functions, objects, shared data, software systems, and so on, useful in extending the capabilities of the CAR system 30, the CAD system 32, the CAM/CIM system 36, the CMM system 38, the PDM system 40, the services/logging system 41, the producibility advisor system 43, the DA system 45, and/or the eCAV system 47. By enabling the processes 12, 14, 16, 18, 20, and 22, for example, via the systems 30, 32, 34, 36, 38, 40, 41, 43, 45, and 47 and their respective extensibility and customization systems 42, 44, 46, 48, 50, 52, 54, 56, 58 and 61, the techniques described herein may provide for a more efficient “cradle-to-grave” product lifecycle management.

It may be beneficial to describe a machine that would incorporate one or more parts manufactured and tracked by the processes 12, 14, 16, 18, 20, and 22, for example, via the CAx system 10. Accordingly, FIG. 3 illustrates an example of a power production system 100 that may be entirely (or partially) conceived, designed, engineered, manufactured, serviced, and tracked by the CAx system 10. As illustrated in FIG. 3, the power production system 100 includes a gas turbine system 102, a monitoring and control system 104, and a fuel supply system 106. The gas turbine system 102 may include a compressor 108, combustion systems 110, fuel nozzles 112, a gas turbine 114, and an exhaust section 118. During operation, the gas turbine system 102 may pull air 120 into the compressor 108, which may then compress the air 120 and move the air 120 to the combustion system 110 (e.g., which may include a number of combustors). In the combustion system 110, the fuel nozzle 112 (or a number of fuel nozzles 112) may inject fuel that mixes with the compressed air 120 to create, for example, an air-fuel mixture.

The air-fuel mixture may combust in the combustion system 110 to generate hot combustion gases, which flow downstream into the turbine 114 to drive one or more turbine stages. For example, the combustion gases may move through the turbine 114 to drive one or more stages of turbine blades 121, which may in turn drive rotation of a shaft system 122. The shaft system 122 may additionally be coupled to one or more compressor stages having compressor blades 123. The shaft 122 may additionally connect to a load 124, such as a generator that uses the torque of the shaft 122 to produce electricity. After passing through the turbine 114, the hot combustion gases may vent as exhaust gases 126 into the environment by way of the exhaust section 118. The exhaust gas 126 may include gases such as carbon dioxide (CO₂), carbon monoxide (CO), nitrogen oxides (NOₓ), and so forth.

The exhaust gas 126 may include thermal energy, and the thermal energy may be recovered by a heat recovery steam generation (HRSG) system 128. In combined cycle systems, such as the power plant 100, hot exhaust 126 may flow from the gas turbine 114 and pass to the HRSG 128, where it may be used to generate high-pressure, high-temperature steam. The steam produced by the HRSG 128 may then be passed through a steam turbine engine for further power generation. In addition, the produced steam may also be supplied to any other processes where steam may be used, such as to a gasifier used to combust the fuel to produce the untreated syngas. The gas turbine engine generation cycle is often referred to as the “topping cycle,” whereas the steam turbine engine generation cycle is often referred to as the “bottoming cycle.” Combining these two cycles may lead to greater efficiencies in both cycles. In particular, exhaust heat from the topping cycle may be captured and used to generate steam for use in the bottoming cycle.

In certain embodiments, the system 100 may also include a controller 130. The controller 130 may be communicatively coupled to a number of sensors 132, a human machine interface (HMI) operator interface 134, and one or more actuators 136 suitable for controlling components of the system 100. The actuators 136 may include valves, switches, positioners, pumps, and the like, suitable for controlling the various components of the system 100. The controller 130 may receive data from the sensors 132, and may be used to control the compressor 108, the combustors 110, the turbine 114, the exhaust section 118, the load 124, the HRSG 128, and so forth.

In certain embodiments, the HMI operator interface 134 may be executable by one or more computer systems of the system 100. A plant operator may interface with the industrial system 100 via the HMI operator interface 134. Accordingly, the HMI operator interface 134 may include various input and output devices (e.g., mouse, keyboard, monitor, touch screen, or other suitable input and/or output device) such that the plant operator may provide commands (e.g., control and/or operational commands) to the controller 130.

The controller 130 may include a processor(s) 140 (e.g., a microprocessor(s)) that may execute software programs to perform the disclosed techniques. Moreover, the processor 140 may include multiple microprocessors, one or more “general-purpose” microprocessors, one or more special-purpose microprocessors, and/or one or more application specific integrated circuits (ASICS), or some combination thereof. For example, the processor 140 may include one or more reduced instruction set (RISC) processors. The controller 130 may include a memory device 142 that may store information such as control software, look up tables, configuration data, etc. The memory device 142 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof). As mentioned earlier, all systems, parts, components and so on, of

Turning now to FIG. 4, the figure is a flowchart illustrating a process 200 suitable for implementing the techniques described herein, including incorporating one or more feedback loops to automatically calibrate manufacturing machines and/or the producibility advisor system 43 based on part inspection and/or part usage. The process 200 may be implemented as computer code or instructions stored in the memory 26 and executable via the processor 24. Additionally or alternatively, the process 200 may be implemented in hardware, such as in a custom chip, FPGA chip, and so on. Further, the process 200 may be executable via the cloud 74.

In the depicted embodiment, the process 200 may create (block 202) a part or product design 204. The part or product design may include a 3D CAD model 206 and associated PMI information 208. The model 206 may be created or designed (block 202) for example, by the design processes 14 (e.g., via the CAD system 32). Likewise, the PMI information 208 may be added during the creation of the model 206 by the CAD processes 14 (e.g., via the CAD system 32). As mentioned earlier, the model 206 may include information such as 3D part information, solid/surface modeling, parametric models, wireframe models, vector models, non-uniform rational basis spline (NURBS) models, geometric models, and the like, describing part geometries and structures. Likewise, the PMI information 208 may include geometric dimensions, tolerances, text (e.g., annotations, notes), other dimensions, material type, material specifications, finishes (e.g., surface finishes), clearances, and so on, associated with the 3D model 206.

The process 200 may then validate the design 204. For example, the producibility advisor system 43 may use the models 206 and/or PMI 208 as well as producibility rules 59 as input and then produce as output producibility reports and/or metrics 212. The producibility reports and/or metrics 212 may then be used to further update the design 204. For example, a determination (decision 214) may be made on whether the findings 212 of the producibility advisor system 43 warrant further design updates. For example, the findings 212 may derive that the machines to be used to manufacture the design 204 may take too long or not include certain manufacturing capabilities necessitated by the design 204. Likewise, the findings 212 may detail that certain specifications (e.g., international standards organization [ISO] specifications, institute of electrical and electronic engineers [IEEE] specifications, and so on) are not met or it would be otherwise advantageous to update the design 204.

If it is determined (decision 214) that the design 204 would benefit from an update, then the process 200 would update (block 216) the design 204, for example, via the CAD system 32 based on the findings 212. If it is determined (decision 214) that no further updates are to be performed, then the process 200 may use a validated design 218 having validated 3D cad model 220 and validated PMI 222. The validated design 218 may then be used, for example, via manufacturing processes 18 and/or CAM/CIM system 36 to create or otherwise manufacture (block 224) a part or product 226.

The part 226 may then be inspected (block 228), for example, by automatically generating CMM system 38 inspection code (e.g., DMIS code, CALYPSO code) from the validated design 218, and then using the CMM system 38 to inspect the part 226. Results 230 of the inspection may then be reported (block 232). For example, the results 230 may be provided to any (or all of the processes 12, 14, 16, 18, 20, 22, the systems 30, 32, 34, 36, 38, 40, 41, 43, 45, and 47, as well as the teams 68, 70. In one embodiment, the results 230 may be derived by the eCAV system 47. For example, the eCAV system 47 may automatically generate a first article inspection report and/or metrics detailing the measured geometries, position of holes, type of holes (e.g., through-holes, partial holes), hole depth, hole diameter, hole shape, distance between edges, surface finish, color, and so on. As depicted, the results 230 may also be provided as input to the DA system 45, which may then derive calibrations (block 234).

As mentioned earlier, the DA system 45 may use the results 230 to automatically generate calibrations for the machine used to produce the part or product (e.g., CAM\CIM system 36 calibrations, CNC machine calibrations, 3D printer calibrations). For example, machine offsets, zeroes, touch offs, cutting compensations, printing bed adjustments, printing bed temperature, and so on, may be adjusted. Additionally or alternatively, the DA system 45 may process the results 230 to automatically generate calibrations for the producibility advisor system 43. For example, the producibility rules 59 may be tuned, updated, added to, deleted, and so on, based on the results 230. The process 200 may then perform (block 236) the calibrations. For example, the machinery may be calibrated (block 236) to more suitably produce the design 204, and the producibility rules 59 may be calibrated to improve the validated design 218.

Technical effects include systems and methods for conceiving, designing, engineering, manufacturing, verifying, and/or servicing/tracking parts or products, such as turbomachinery parts or products. A producibility advisor may take as input a part design and automatically derive if the part design is producible via certain machinery. Once the part is produced, a Coordinate-Measuring Machine (CMM) may automatically inspect the part. Results of the inspection may be provided to an electronic Characteristic Accountability & Verification (eCAV) system. The eCAV system may then communicate with a Data Analysis (DA) system that may derive certain conclusions based around machine capability for the part and may then employ, for example, a logic tree to trigger a calibration to machine settings, to the producibility advisor system, or a combination thereof. By automatically calibrating machine settings and/or the producibility advisor system to improve the design via feedback, the part or product may be manufactured more efficiently and accurately.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A computer-aided technologies (CAx) system, comprising:
a memory storing a producibility advisor system; and
a processor communicatively coupled to the memory and configured to execute the producibility advisory system to:
receive a part design as input; and
derive a producibility record based on the part design, wherein the producibility record comprises a measure of an ability of a machine to manufacture a part based on the part design.

2. The system of claim 1, wherein the memory is storing producibility rules and wherein the processor is configured to execute the producibility advisory system to derive the producibility record based on the producibility rules.

3. The system of claim 2, wherein the producibility rules comprise expert system rules, classification rules, formal logic rules, first order logic rules, propositional logic rules, or a combination thereof.

4. The system of claim 1, wherein the memory comprises a computer aided manufacturing (CAM) system configured to control the machine and wherein the processor is configured to manufacture the part via the CAM system if the processor determines that the part is manufacturable based on the measure.

5. The system of claim 1, wherein the memory is storing a Coordinate-Measuring Machine (CMM) inspection program, and wherein the processor is configured to execute the CMM inspection program via a CMM system to inspect the part and to produce an inspection record.

6. The system of claim 5, wherein the memory is storing an electronic Characteristic Accountability & Verification (eCAV) system, and wherein the processor is configured to execute the eCAV system to take the inspection record as input and to produce a first article inspection record.

7. The system of claim 6, wherein the memory is storing a data analysis (DA) system, and wherein the processor is configured to execute the DA system to take the first article inspection record as input and to produce a calibration derivation as output, wherein the calibration derivation comprises a first calibration of a machine and wherein the machine is configured to manufacture the part.

8. The system of claim 7, wherein the calibration derivation comprises a second calibration of the producibility advisor system.

9. The system of claim 1, wherein the part design comprises a three-dimensional computer aided design (CAD) model and associated product and manufacturing information (PMI).

10. A method, comprising:
receiving, via a processor, a part design, wherein the part design is created via a computer aided design (CAD) system;
providing as input, via the processor, the part design to a producibility advisor system;
executing the producibility advisor system, via the processor, to derive a producibility report based on the part design, wherein the producibility report comprises a measure of an ability of a machine to manufacture a part based on the part design.

11. The method of claim 10, comprising manufacturing the part via a computer aided manufacturing (CAM) system configured to control the machine if the processor determines that the part is manufacturable based on the measure.

12. The method of claim 11, comprising creating, via the processor, a Coordinate-Measuring Machine (CMM) inspection program and inspecting the part via a CMM system executing the CMM inspection program to produce an inspection record.

13. The method of claim 12, comprising executing an electronic Characteristic Accountability & Verification (eCAV) system, via the processor, to take the inspection record as input and to produce a first article inspection record.

14. The method of claim 13, comprising executing a data analysis (DA) system, via the processor, to take the first article inspection record as input and to produce a calibration derivation as output, wherein the calibration derivation comprises a first calibration of a machine and wherein the machine is configured to manufacture the part.

15. The method of claim 14, wherein the calibration derivation comprises a second calibration of the producibility advisor system, and applying the second calibration to the producibility advisor system.

16. One or more tangible, non-transitory, machine-readable media comprising instructions configured to cause a processor to:
receive a part design, wherein the part design is created via a computer aided design (CAD) system;
provide as input the part design to a producibility advisor system;
execute the producibility advisor system to derive a producibility report based on the part design, wherein the producibility report comprises a measure of an ability of a machine to manufacture a part based on the part design.

17. The one or more machine-readable media of claim 16, comprising instructions configured to cause the processor to manufacture the part via a computer aided manufacturing (CAM) system configured to control the machine if the processor determines that the part is manufacturable based on the measure.

18. The one or more machine-readable media of claim 16, comprising instructions configured to cause the processor to create a Coordinate-Measuring Machine (CMM) inspection program and to execute the CMM inspection program via a CMM system to inspect the part and to produce an inspection record.

19. The one or more machine-readable media of claim 18, comprising instructions configured to cause the processor to execute an electronic Characteristic Accountability & Verification (eCAV) system, via the processor, to take the inspection record as input and to produce a first article inspection record.

20. The one or more machine-readable media of claim 19, comprising instructions configured to cause the processor to execute a data analysis (DA) system, via the processor, to take the first article inspection record as input and to produce a calibration derivation as output, wherein the calibration derivation comprises a first calibration of a machine and wherein the machine is configured to manufacture the part.
